(19) United States
(12) Patent Application Publication
(10) Pub. No.: US 2008/0140638 A1
(43) Pub. Date: Jun. 12, 2008

(54) Method And System For Identifiying An Object In A Photograph, Programme, Recording Medium, Terminal And Server For Implementing Said System

(75) Inventor: Adrien Bruno, Grasse (FR)

Correspondence Address: YOUNG & THOMPSON, 209 Madison Street, Suite 500, ALEXANDRIA, VA, 22314, US

(73) Assignee: France Telecom, Paris (FR)

(21) Appl. No.: 11/662,470

(22) PCT Filed: Sep. 14, 2005
(86) PCT No.: PCT/FR05/02280

§ 371 Date: Mar. 12, 2007

(30) Foreign Application Priority Data
Sep. 15, 2004 (FR) 0409769

(51) Int. Cl. G06F 7/10; G06F 17/30

(52) U.S. Cl. 707/4; 707/E17.018

(57) ABSTRACT

The invention concerns a method for automatically identifying an object in a photograph comprising: a step (214) of extracting a geographical position and a viewing direction of an objective from data associated with a photograph; a step (234) of determining a straight line oriented on the basis of the extracted viewing direction; a step (236) of selecting in a cartographic database at least one object based on the distance calculated between its geographical position and the oriented straight line; a step (242) of displaying data on the or each selected object.

The present invention relates to a method and a system for identifying an object in a photograph, and a program, a storage medium, a terminal and a server for implementing the system.

It is now possible for a user to use a computer to download very many photographs representing landscapes. Unfortunately, most of the photographs downloaded in this way, for example from the Internet network, have no legends so that it is difficult to identify one of the objects present in the photographed landscape.

The invention seeks to remedy this drawback by proposing a method of automatically identifying an object in a photograph.

The object of the invention is therefore a method of automatically identifying an object in a photograph taken from a camera equipped with a lens, this method comprising:
a step for extracting a geographic position and a viewing direction of the lens based on data associated with the photograph,
a step for determining an oriented straight line passing through the extracted-geographic position and a geographic position corresponding to the object of the photograph to be identified, according to the extracted viewing direction,
a step for selecting from a cartographic database at least one object according to a distance calculated between its geographic position and the determined oriented straight line, the cartographic database associating a geographic position with each object, and
a step for displaying information on the or each selected object.

The above method makes it possible to automatically identify at least one object in the photograph. For this, this method exploits the fact that, from the moment when the geographic position and the viewing direction of the lens are known, it is possible to select from a cartographic database at least one object corresponding to one of those photographs. Information on the selected object can then be used to identify the object present in this photograph.

The embodiments of this method can include one or more of the following characteristics:
a step for acquiring the coordinates of a point on the photograph, a step for correcting the extracted viewing direction according to the acquired coordinates and a field angle of the lens of the camera, and the determination step uses the corrected direction to determine the oriented straight line;
the selection step also consists in selecting only the object closest to the extracted geographic position from the objects selected as being the closest to the determined oriented straight line;
the selection step also consists in selecting the or each object according to a field angle of the lens.

Another subject of the invention is a viewing process and a selection process suitable for use in the identification method described above.

Another subject of the invention is a computer program and an information storage medium comprising instructions for executing an identification method, a viewing process or a selection process such as those described above, when the instructions are executed by an electronic computer.

Another subject of the invention is a system of automatically identifying an object in a photograph taken from a camera equipped with a lens; this system comprises:
a module for extracting a geographic position and a viewing direction of the lens based on data associated with the photograph,
a module for determining an oriented straight line passing through the extracted geographic position and through a geographic position corresponding to the object of the photograph to be identified, according to the extracted viewing direction,
a module for selecting from the cartographic database at least one object according to a distance calculated between its geographic position and the determined oriented straight line, the cartographic database associating a geographic position with each object, and
a unit for displaying information on the or each selected object.

The embodiments of the system can comprise one or more of the following characteristics:
a module for acquiring the coordinates of a point on the photograph, and a module for correcting the extracted direction according to the acquired coordinates and a field angle of the camera, and the determination module uses the corrected direction to determine the oriented straight line;
the selection module is also suitable for selecting only the object closest to the extracted geographic position out of the objects selected as being closest to the determined oriented straight line;
the selection module is also suitable for selecting the or each object according to a field angle of the lens.

Another subject of the invention is a viewing terminal and a computer server designed to be used in the system described above.

The invention will be better understood from reading the description that follows, given purely as an example and with reference to the drawings in which:

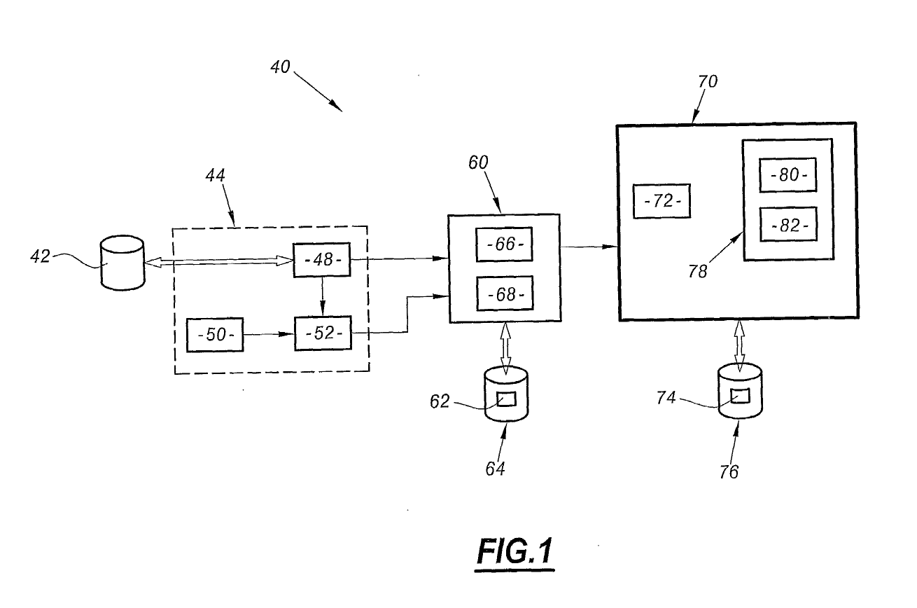

FIG. 1 is a diagrammatic illustration of the general architecture of a system of automatically identifying an object in a photograph;

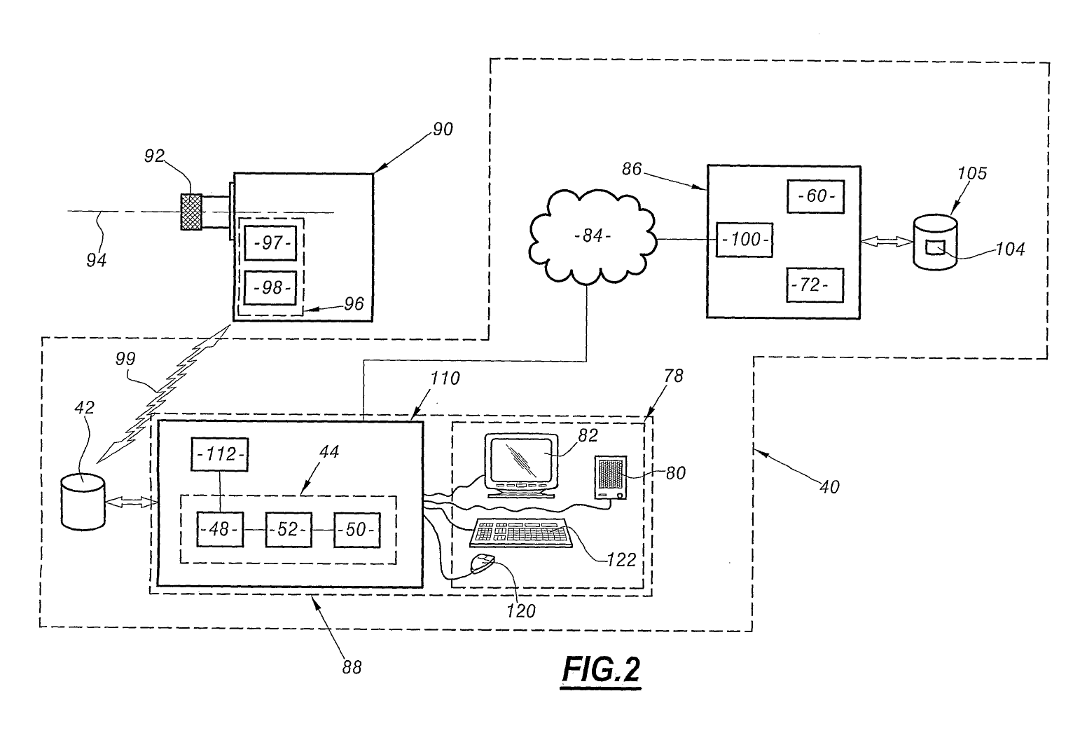

FIG. 2 is a diagrammatic illustration of the architecture of a particular exemplary embodiment of the system of FIG. 1;

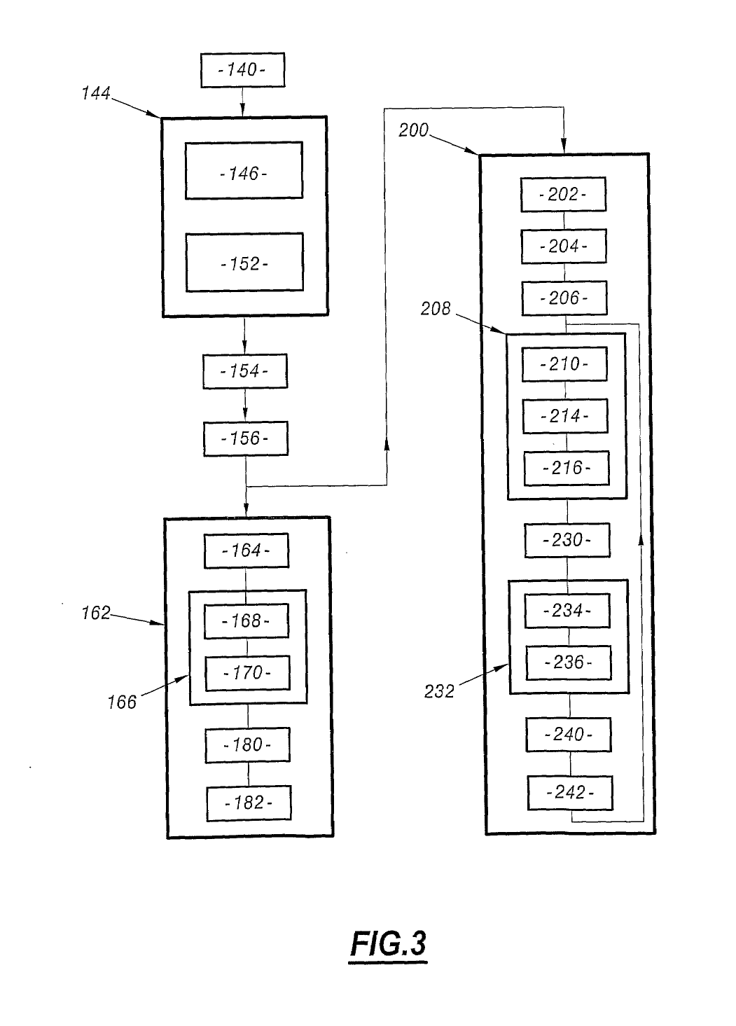

FIG. 3 is a flow diagram of a method of automatically identifying an object in a photograph; and

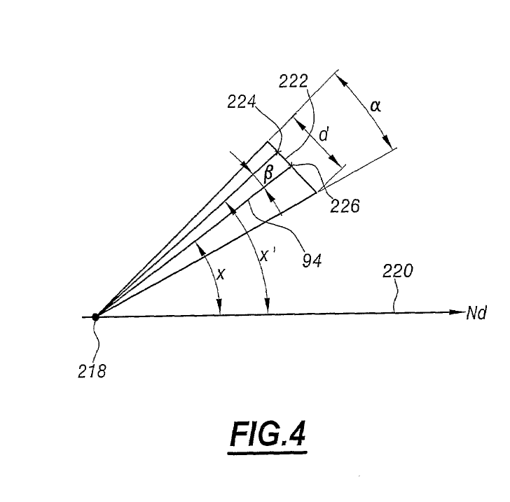

FIG. 4 is a diagram illustrating a method for correcting a direction according to the position of a point in a photograph.

FIG. 1 represents a system, designated by the general reference 40, of identifying an object visible in a photograph.

Here, each photograph is associated with data hereinafter called “metadata”, such as, for example, that encountered in the storage format of EXIF (Exchangeable Image File) photographs. This metadata comprises in particular:
the geographic position of the lens of the camera having been used to take the photograph at the time when this photograph was taken,
the viewing direction of the lens at the time when the photograph was taken,
the field angle of the lens or the value of the focal distance of the lens and the format of the photograph.

Throughout this text, the expression “geographic position” denotes coordinates within a three dimensional frame of reference, these coordinates being representative of the latitude, the longitude and the altitude of the position.

The geographic position and the viewing direction of the lens are, for example, measured at the time when the photograph is taken, then stored in the metadata associated with this photograph. Similarly, the field angle or the focal distance and the format of the photograph are recorded then stored in the metadata associated with this photograph.

In FIG. 1, the metadata and the photographs are stored in a memory 42.

The system 40 comprises a unit 44 for processing the metadata stored in the memory 42.

To process this metadata, the unit 44 comprises a module 48 for extracting the geographic position of the lens, the viewing direction of the lens and the field angle of the lens in the metadata stored in the memory 46.

Here the unit 44 also comprises a module 50 for acquiring the coordinates of a point in a photograph and a module 52 for correcting the direction extracted by the module 48.

The module 50 is suitable for acquiring the coordinates of a point in a photograph in a two-dimensional orthonormed frame of reference, the origin of which is, for example, merged with the center of the photograph. This module comprises an output connected to the module 52 for transmitting the acquired coordinates to the module 52.

The module 52 is suitable for correcting the direction extracted by the module 48 to produce a corrected direction passing through the geographic position of the photographing point and through a geographic position corresponding to the point of the photograph whose coordinates have been acquired. To this end, the module 52 uses the field angle of the camera. The data on the field angle is extracted from the metadata contained in the memory 46. The term “field angle” is used here to mean the angle that defines the limits of a scene visible through the lens of the camera.

The unit 44 also comprises two outputs connected to a database engine 60 for transmitting to the latter the position extracted by the module 48 and the corrected direction. The engine 60 is suitable for selecting an object in a cartographic database 62 stored in a memory 64. The database 62 contains the geographic position of a large number of objects associated with an identifier of each of these objects. These objects are, for example, historical monuments, mountains, place names. Here, each of these objects is likely to be seen and identified by the naked eye by a human being.

In order to select from the database 62 at least one object according to the extracted position and the corrected direction, the engine 60 comprises a module 66 for determining an oriented straight line and a module 68 for selecting an object close to the determined straight line. For example, the module 66 determines the equation of the straight line passing through the extracted geographic position and having as its direction that corrected by the module 52.

The module 68 is suitable for selecting from the database 62 the object or objects closest to the straight line determined by the module 66 and that are visible in the photograph.

This module 68 will be described in more detail in relation to FIG. 3.

The engine 60 comprises an output via which the identifiers of the objects selected by the module 68 are transmitted. This output is connected to a unit 70 for displaying information on the or each selected object.

The engine 60 is, preferably, produced in the form of a computer program comprising instructions for executing a selection method as described in relation to FIG. 3, when these instructions are executed by an electronic computer.

The unit 70 comprises a module 72 for creating a legend from additional information contained in a database 74 stored in a memory 76. The database 74 associates with each object identifier additional information such as, for example, the name of the object, its intrinsic characteristics, its history. This information is stored in an appropriate format that enables it to be viewed. For example, in this case, the name of the objects is stored in the form of an alphanumeric string whereas the history of an object is stored in the form of an audio file.

The unit 70 also comprises a man/machine interface 78. Here, this man/machine interface 78 is equipped with a loudspeaker 80 suitable for playing back audio files to a user and a screen 82 suitable for displaying the photograph taken by the camera in which the legend created by the module 72 is, for example, embedded.

FIG. 2 represents a particular exemplary embodiment of the system 40. The elements already described in relation to FIG. 1 are given the same numeric references in FIG. 2.

Generally, the system 40 comprises a computer server 86 connected via an information transmission network 84 to a terminal 88 for viewing photographs.

FIG. 2 also shows a camera 90 equipped with a lens 92. The lens 92 has a viewing direction 94 which corresponds to the optical center line of this lens.

This camera 90 is suitable for storing in the memory 42 of the system 40 the photographs and the corresponding metadata comprising in particular the geographic position, the viewing direction and the field angle for each of these photographs. To this end, the camera 90 is equipped with a unit 96 for measuring the geographic position and the viewing direction of the lens 92. As an example, this unit 96 is implemented using a geographic position sensor 97 and an orientation sensor 98. The sensor 97 is, for example, a GPS (Global Positioning System) sensor and the sensor 98 is, for example, implemented using three gyroscopes arranged perpendicularly to each other. The unit 96 is also suitable for recording the settings of the camera 90 such as the field angle of the lens, the date, the time and the brightness.

The camera 90 is suitable for storing the photographs and the corresponding metadata in the memory 42 via an information transmission link 99 such as, for example, a wireless link.

The camera 90 is, for example, a digital camera or even a mobile telephone equipped with a camera.

The server 86 is equipped with a modem 100 for exchanging information with the terminal 88 via the network 84. The database engine 60 and the module 72 for creating a legend are located in the server 86.

In this embodiment, the databases 62 and 74 of the system 40 have been combined in one and the same database 104 stored in a memory 105 associated with the server 86. Thus, the database 104 combines, for each object, its identifier, its geographic position and the additional information relating to it. The memory 105 also contains, for example, the instructions of the computer program corresponding to the engine 60 and to the module 72, the server 86 then fulfilling the role of the electronic computer suitable for executing these instructions.

The terminal 88 is, for example, implemented from a conventional computer equipped with a central processing unit 110 and the man/machine interface 78.

The unit 110 is fitted with a modem 112 for exchanging information with the server 86 via the network 84.

The modules 48, 50 and 52 are located in the central processing unit 110. This central processing unit 110 is associated with the memory 42 containing the photographs and the metadata.

In this embodiment, the memory 46 comprises the instructions of a computer program corresponding to the modules 48, 50 and 52 and the central processing unit 110 then acts as the electronic computer suitable for executing these instructions.

Here, the screen and a loudspeaker of the computer respectively correspond to the screen 82 and to the loudspeaker 80 of the interface 78. This interface 78 also comprises in this embodiment a mouse 120 and a keyboard 122.

The operation of the system 40 will now be described in relation to the method of FIG. 3.

Initially, a user of the camera 90 takes a photograph in a step 140.

Then, the metadata associated with the photograph that has just been taken is created in a step 144. More specifically, in an operation 146, the sensor 97 measures the position of the camera 90 and the sensor 98 measures the orientation of the direction 94 relative to the horizontal and relative to the magnetic north. The tilt of the camera 90 relative to the horizontal is also measured in this operation 146 to determine the tilt of the photograph relative to the horizontal.

In the step 144, the unit 96 also records, in an operation 152, the settings of the camera having been used to take the photograph. In particular, in this operation 152, the camera 90 records the field angle of the lens at the moment when the photograph was taken. Other information such as, for example, the date, the time, the brightness and the shutter opening time are also recorded in this operation 152.

Once the metadata has been created, it is associated, in a step 154, with the photograph taken in the step 140. For example, in the step 154, the photograph and metadata are stored in an EXIF format.

Next, the metadata and the photograph are transmitted via the link 99, then stored, in a step 156, in the memory 42.

After, a user of the terminal 88 can, if he wishes proceed with a phase 162, for automatically creating a legend for one of the photographs stored in the memory 42. In this phase 162, the terminal 88 transmits to the engine 60, in a step 164, the geographic position, the viewing direction and the field angle associated with one of the photographs stored in the memory 42. The engine 60 receives the data transmitted in the step 164.

The engine 60 then selects, according to the received data, in a step 166, at least one object in the database 104. More specifically, in the step 166, the module 66 determines, in an operation 168, the oriented straight line passing through the received geographic position and having as its direction the received viewing direction. Then, in an operation 170, the module 68 selects from the database 104 the or each object whose geographic position is closest to the oriented straight line determined in the operation 168. For this, for example, the module 68 calculates the shortest distance separating each object from the oriented straight line and it selects only the or each object separated from the oriented straight line by a distance less than a threshold. This threshold is established by the module 68 according to the value of the received field angle so as to eliminate all the objects that are not visible in the photograph. Furthermore, this threshold is determined to select only the objects present on the received direction.

Then, in a step 180, the module 72 creates a legend for the photograph according to complementary information associated with the objects selected by the engine 60. For example, it creates the following legend “photograph taken facing (north-east) the clock tower of the “plan de Grâce”, Saturday 14 February at 8:48 am”.

This exemplary legend is constructed using information on the object located in the viewing direction, and the date and time extracted from the metadata associated with the photograph.

Then, the created legend is transmitted to the terminal 88, in a step 182, and stored in the metadata associated with this photograph.

The user can also proceed with a phase 200 for viewing a photograph on the terminal 88. This phase 200 begins with the display, in a step 202, of a geographic map on the screen 82, on which are placed photographing points, each photographing point being representative of the geographic position stored in the metadata associated with a photograph.

The user uses the mouse 120, in a step 204, to select one of these photographing points. The terminal 88 then automatically displays, in a step 206, the photograph taken from this photographing point on the screen 82. If a legend has already been created for this photograph, preferably, the photograph displayed on the screen 82 also comprises, embedded within it, the legend created by the module 72.

The user then proceeds with a step 208 for identifying an object visible in the photograph. For this, he selects a particular point of the photograph corresponding to an object to be identified using the mouse, for example. The module 50 acquires, in an operation 210, the coordinates of the point selected by the user in the frame of reference linked to the center of the photograph. These coordinates are denoted (a, b). Then, in an operation 214, the module 48 extracts the geographic position of the photographing point and the viewing direction, from the metadata stored in the memory 46.

Then, in an operation 216, the module 52 corrects the direction extracted from the metadata to deduce from it a corrected direction. The corrected direction coincides with that of a straight line passing through the extracted geographic position and through the geographic position of an object corresponding to the point selected in the photograph. For this, the module 52 uses the field angle α stored in the metadata associated with the photograph. This field angle α is represented in FIG. 4. In this same FIG. 4, the position of the photographing point is represented by a point 218. An angle x represents the angle between the direction 94 and the magnetic north direction indicated by an arrow 220. To simplify the explanation, the correction of the angle x will be described here in the particular case of a photograph 222 taken horizontally such that there is no need to take account of the tilt of the photograph or of the camera 90 relative to the horizontal. The position of the point selected by the user is represented by a cross 224 whereas the center of the frame of reference linked to the photograph is represented by a cross 226. The distance between these two crosses 224 and 226 corresponds to the value of the abscissa “a”. The known length of a horizontal edge of the photograph is here denoted d. In these conditions, an angle β made by the corrected direction relative to the direction 94 is calculated using the following relation:

$$β = \frac{α \cdot α}{d}$$

Once this angle β is calculated, the latter is added to the angle x. There is thus obtained an angle x′ made by the corrected direction relative to magnetic north. By performing similar operations, the module 52 also calculates an angle y′ that is made by the corrected direction relative to the horizontal.

The position extracted from the metadata and the corrected direction are then transmitted, in a step 230, to the engine 60 via the network 84. The engine 60 selects, in a step 232, according to the data received, the or each object close to the oriented straight line passing through the extracted position and having the corrected direction. This step 232 comprises an operation 234 for determining the oriented straight line, just like the operation 168, and an operation 236 for selecting the objects closest to the oriented straight line.

In this operation 236, the engine 60 selects from the database 104 the object which:
is close to the oriented straight line,
is included in the frame of the photograph, and
is also the closest to the geographic position of the photographing point.

The last condition makes it possible to select only an object that is visible in the photograph. In the operation 236, an object is considered as being close to the oriented straight line if, for example, the shortest distance that separates it from this straight line is less than a pre-established threshold.

Once the engine 60 has selected the visible object present in the corrected direction, the identifier of this object, and the complementary information that is associated with it, is transmitted to the terminal 88 in a step 240.

The unit 78 presents, in a step 242, the information received to the user. For example, the screen 82 displays some of this information and the loudspeaker 80 plays back the audio files.

Then, the user can select another point of the photograph and the steps 208 to 240 are repeated.

Here, the metadata is associated with the photograph by using the EXIF format. As a variant, the EXIF format is replaced by the MPEG7 format.

Numerous other embodiments of the system 40 are possible. For example, instead of dividing up the elements of the system 40 between, on the one hand, one or more local viewing terminals and, on the other hand, a computer server, it is possible to locate all the elements of the system 40 in the viewing station. Conversely, it is also possible to locate the processing unit 44 in the remote computer server which will then be associated with the memory 42. In this latter embodiment, the viewing station also comprises the information display unit.

As a variant, the module 72 for creating legends and the phase 162 are eliminated. In this variant, the display unit is reduced to a man/machine interface.

In a simplified embodiment, the operations 210 and 216 are eliminated. The system is then only capable of identifying the object located in the center of the photograph on the viewing line.

1. A method of automatically identifying an object in a photograph taken from a camera equipped with a lens, characterized in that it comprises:
a step (214) for extracting a geographic position and a viewing direction of the lens based on data associated with the photograph,
a step (234) for determining an oriented straight line passing through the extracted geographic position and a geographic position corresponding to the object of the photograph to be identified, according to the extracted viewing direction,
a step (236) for selecting from a cartographic database at least one object according to a distance calculated between its geographic position and the determined oriented straight line, the cartographic database associating a geographic position with each object, and
a step (242) for displaying information on the or each selected object, and
characterized in that it comprises:
a step (210) for acquiring the coordinates of a point on the photograph,
a step (216) for correcting the extracted viewing direction according to the acquired coordinates and a field angle of the lens of the camera, and
in that the determination step uses the corrected direction to determine the oriented straight line.

2. The method as claimed in claim 1, characterized in that the selection step (236) also consists in selecting only the object closest to the extracted geographic position from the objects selected as being the closest to the determined oriented straight line.

3. The method as claimed in claim 1, characterized in that the selection step (236) also consists in selecting the or each object according to a field angle of the lens.

4. A process for selecting an object in a cartographic database listing the geographic positions of objects, this process being suitable for use in an identification method as claimed in claim 1, characterized in that it comprises the step (236) for selecting from the cartographic database at least one object whose geographic coordinates are the closest to the determined oriented straight line.

5. A computer program, characterized in that it comprises instructions for executing a method or a process as claimed in claim 1, when said instructions are executed by an electronic computer.

6. An information storage medium, characterized in that it comprises instructions for executing a method or a process as claimed in claim 1, when said instructions are executed by an electronic computer.

7. A system of automatically identifying an object in a photograph taken from a camera equipped with a lens, characterized in that this system comprises:
a module (48) for extracting a geographic position and a viewing direction of the lens based on data associated with the photograph,
a module (66) for determining an oriented straight line passing through the extracted geographic position and through a geographic position corresponding to the object of the photograph to be identified, according to the extracted viewing direction,
a module (68) for selecting from the cartographic database at least one object according to a distance calculated between its geographic position and the determined oriented straight line, the cartographic database associating a geographic position with each object, and
a unit (70) for displaying information on the or each selected object, and
characterized in that it comprises:
a module (50) for acquiring the coordinates of a point on the photograph, and
a module (52) for correcting the extracted direction according to the acquired coordinates and a field angle of the camera, and
in that the determination module uses the corrected direction to determine the oriented straight line.

8. The system as claimed in claim 7, characterized in that the selection module is also suitable for selecting only the object closest to the extracted geographic position out of the objects selected as being closest to the determined oriented straight line.

9. The system as claimed in claim 7, characterized in that the selection module is also suitable for selecting the or each object according to a field angle of the lens.

10. A viewing terminal designed to be used in an identification system as claimed in claim 7, characterized in that it comprises the unit (70) for presenting information on the or each selected object.

11. A computer server suitable for use in a system as claimed in claim 7, characterized in that the computer server comprises the module (68) for selecting from the cartographic database at least one object according to the distance separating the extracted geographic position from the determined oriented straight line.

12. A unit for processing metadata suitable for use in a system as claimed in claim 7, characterized in that it comprises the module (52) for correcting the extracted direction according to the acquired coordinates and a field angle of the camera.

13. The system as claimed in claim 8, characterized in that the selection module is also suitable for selecting the or each object according to a field angle of the lens.

14. A viewing terminal designed to be used in an identification system as claimed in claim 8, characterized in that it comprises the unit (70) for presenting information on the or each selected object.

15. A computer server suitable for use in a system as claimed in claim 8, characterized in that the computer server comprises the module (68) for selecting from the cartographic database at least one object according to the distance separating the extracted geographic position from the determined oriented straight line.

16. A unit for processing metadata suitable for use in a system as claimed in claim 8, characterized in that it comprises the module (52) for correcting the extracted direction according to the acquired coordinates and a field angle of the camera.

17. The method as claimed in claim 2, characterized in that the selection step (236) also consists in selecting the or each object according to a field angle of the lens.

18. A process for selecting an object in a cartographic database listing the geographic positions of objects, this process being suitable for use in an identification method as claimed in claim 2, characterized in that it comprises the step (236) for selecting from the cartographic database at least one object whose geographic coordinates are the closest to the determined oriented straight line.
